(19) United States
(12) Patent Application Publication
(10) Pub. No.: US 2020/0274214 A1
(43) Pub. Date: Aug. 27, 2020

(54) COOLING SYSTEM FOR ELECTRIC VEHICLE

(71) Applicants: Hyundai Motor Company, Seoul (KR); Kia Motors Corporation, Seoul (KR)

(72) Inventors: Kyeongho Kim, Anyang (KR); Danghee Park, Seoul (KR); Jiwoong Jung, Anyang (KR); Yeon Man Jeong, Yongin (KR); Seungyeon Han, Seongnam (KR)

(21) Appl. No.: 16/521,108

(22) Filed: Jul. 24, 2019

(30) Foreign Application Priority Data
Feb. 27, 2019 (KR) 10-2019-0023227

(51) Int. Cl. H01M 10/6568; B60L 58/26; B60L 58/27; B60H 1/00; H01M 10/625; H01M 10/613; H01M 10/63; H01M 10/663

(52) U.S. Cl. CPC H01M 10/6568; B60L 58/26; B60L 58/27; B60H 1/00278; B60K 6/22; H01M 10/613; H01M 10/63; H01M 10/663; H01M 10/625

(57) ABSTRACT

A cooling system of an electric vehicle includes: an integral valve with one or more coolant inlets and two or more coolant outlets, and which selectively discharges coolant through one of the coolant outlets; coolant paths that are connected with each other such that the coolant discharged through one of the coolant outlets is introduced back into the integral valve through the one or more coolant inlets after being supplied to a portion where coolant circulation is required; and a temperature controller that selectively controls a temperature of the coolant. The integral valve, at least a portion of the plurality of coolant paths, and the temperature controller may form one valve module.

### CROSS-REFERENCE TO RELATED APPLICATION

This application claims under 35 U.S.C. § 119(a) the benefit of Korean Patent Application No. 10-2019-0023227 filed in the Korean Intellectual Property Office on Feb. 27, 2019, the entire contents of which are incorporated herein by reference.

### BACKGROUND

### (a) Technical Field

The present disclosure relates to a cooling system of an electric vehicle, more particularly, to the cooling system of the electric vehicle capable of improving cooling efficiency of an electrically powered device.

### (b) Description of the Related Art

In general, an electric vehicle (EV) is equipped with a driving motor, a transmission, and power electronics (PE). Here, the term “electric vehicle” is a generic name of a vehicle in which electrical power is used as a power source for the vehicle.

The power electronics include an inverter, a DC-DC converter, a junction box, a virtual engine sound system (VESS), and a charger. The inverter is a device that converts direct current power to alternating current power, and the DC-DC converter is an electronic circuit device that converts a DC voltage of a certain voltage to a DC voltage of a different voltage. In addition, the junction box is a box for interconversion of several single connectors and a multi-connector, and the charger is a device provided to charge a high-voltage battery of the electric vehicle.

In an electric vehicle, cooling of the high-voltage battery and the electrically powered electronic components greatly affects the performance of the vehicle, and determines the lifetime of the high-voltage battery and the electrically powered electronic components. In order to effectively implement cooling, a method of changing the circulation path of the coolant depending on an operating state of the vehicle typically is used. Particularly, in the method of changing the circulation path of the coolant, a method of lowering a temperature of the coolant by using a battery chiller or a method of raising the temperature of the coolant by using a battery heater may be used.

The conventional methods can improve the efficiency of the high voltage battery but they may complicate a layout of coolant paths and require components to differentiate the circulation paths of the coolant, and in the complex layout of the coolant paths, the number of parts may be increased to differentiate the circulation paths, of the coolant and there may be a spatial constraint in arrangements of the battery chiller and the battery heater on the coolant paths.

The above information disclosed in this Background section is only for enhancement of understanding of the background of the disclosure and therefore it may contain information that does not form the prior art that is already known in this country to a person of ordinary skill in the art.

### SUMMARY

The present disclosure provides a cooling system of an electric vehicle, which can improve cooling efficiency of an electrically powered device with a simple configuration while minimizing the need to perform additional heating and cooling of a coolant, for example, by using a battery heater and/or a battery chiller.

A cooling system of an electric vehicle according to an exemplary embodiment of the present disclosure is configured to change a circulation path of coolant according to operation of a valve module, and includes: an integral valve that supplies a coolant to a portion where circulation of the coolant is required while cooling a power source of the electric vehicle, and then receives the coolant to supply the received coolant back to the power source and the portion where the coolant circulation is required; an integral valve inlet path through which the coolant is introduced into the integral valve; a first integral valve outlet path, which is one outlet through which the coolant is selectively discharged from the integral valve; a second integral valve outlet path, which is another coolant outlet through which the coolant is selectively discharged from the integral valve; a temperature controller provided for passing the coolant passing through the second integral valve outlet path and selectively controlling the temperature of the coolant passing therethrough; an integrated battery cooling-cycle branch communicating with the first integral valve outlet path, and the second integral valve outlet path; a first integrated battery cooling-cycle branch outlet path, which is one outlet through which the coolant is discharged from the integrated battery cooling-cycle branch; an integrated battery cooling-cycle branch inlet path (different from the first integral valve outlet path and the second integral valve outlet path) through which the coolant is introduced into the integrated battery cooling-cycle branch; and a second integrated battery cooling-cycle branch outlet path, which is another outlet through which the coolant is discharged from the integrated battery cooling-cycle branch.

The integral valve inlet path, the first integral valve outlet path, and the second integral valve outlet path may be formed in the integral valve.

The first integrated battery cooling-cycle branch outlet path, the integrated battery cooling-cycle branch inlet path, and the second integrated battery cooling-cycle branch outlet path may be formed in the integrated battery cooling-cycle branch.

The first integrated battery cooling-cycle branch outlet path may be disposed while opposing the first integral valve outlet path such that the coolant introduced into the integrated battery cooling-cycle branch through the first integral valve outlet path is discharged through the first integral valve outlet path.

The first integrated battery cooling-cycle branch outlet path and the first integral valve outlet path may be disposed along a length direction of the integrated battery cooling-cycle branch, which is a direction in which the coolant circulates in the integrated battery cooling-cycle branch, the second integral valve outlet path is disposed between the first integral valve outlet path and the second integrated battery cooling-cycle branch outlet path, and the integrated battery cooling-cycle branch inlet path is disposed between the first integral valve outlet path and the second integral valve outlet path.

The valve module may further include a check valve that is disposed between the second integral valve outlet path and the integrated battery cooling-cycle branch inlet path in the length direction of the integrated battery cooling-cycle branch to prevent a coolant that has passed through the second integral valve outlet path from flowing backward toward the first integral valve outlet path, the first integrated battery cooling-cycle branch outlet path, and the integrated battery cooling-cycle branch inlet path when circulating to the second integrated battery cooling-cycle branch outlet path through the integrated battery cooling-cycle branch.

The coolant discharged through the first integrated battery cooling-cycle branch outlet from the integrated battery cooling-cycle branch may be introduced into the integrated battery cooling-cycle branch through the integrated battery cooling-cycle branch inlet path after passing through a first circulation path, and a radiator may be provided on the first circulation path such that a coolant passing through the first circulation path passes through the radiator.

The coolant discharged through the second integrated battery cooling-cycle branch outlet path from the integrated battery cooling-cycle branch may be introduced through the integral valve inlet path after passing through a second circulation path, and an electrically powered device may be provided on the second circulation path such that the coolant passing through the second circulation path passes through the electrically powered device.

When the integral valve operates to open the first integral valve outlet path and close the second integral valve outlet path, the coolant discharged through the first integral valve outlet path from the integral valve may sequentially pass through the integrated battery cooling-cycle branch, the first integrated battery cooling-cycle branch outlet path, the first circulation path, the integrated battery cooling-cycle branch inlet path, the integrated battery cooling-cycle branch, the second integrated battery cooling-cycle branch outlet path, and the second circulation path, and the integrated battery cooling-cycle branch inlet path, and then is introduced into the integral valve.

The operation of the integral valve may be carried out when a coolant needs to be cooled by using the radiator in a coolant high-temperature environment.

When the integral valve operates to close the first integral valve outlet path and open the second integral valve outlet path, the coolant discharged through the second integral valve outlet path from the integral valve may be introduced into the integral valve after sequentially passing through the integrated battery cooling-cycle branch, the second integrated battery cooling-cycle branch outlet, the second circulation path, and the integrated battery cooling-cycle branch inlet path.

The temperature controller may further include a heat coil selectively generating heat to heat the coolant passing through the second integral valve outlet path; and a coil heating portion provided to be connected to the heat coil to induce heat generation of the heat coil.

When the heat coil generates heat, the coolant passing through the second integral valve outlet path may rise in temperature by heat exchange with the heat coil while passing through the temperature controller, and then may pass through the second circulation path.

The operation of the integral valve may be carried out when the coolant does not need to be cooled by using the radiator in a coolant low-temperature environment, and the operation of the heat coil may be carried out when the coolant introduced into the temperature controller needs to be heated.

The temperature controller may further include a refrigerant circulation path through which a low-temperature refrigerant is selectively passed to cool the coolant passing through the second integral valve outlet path.

A refrigerant passed through the refrigerant circulation path may be supplied from an air conditioner.

The refrigerant circulation path may be provided to perform heat exchange between the refrigerant and the coolant while being distinguished from a path of the coolant.

When a low-temperature refrigerant passes through the refrigerant circulation path, the coolant passing through the second integral valve outlet path may lower in temperature by heat exchange with the refrigerant while passing through the temperature controller, and then passes through the second circulation path.

The operation of the integral valve may be carried out when the coolant does not need to be cooled by using the radiator in a coolant low-temperature environment, and the operation of the refrigerant circulation paths may be carried out when the coolant that is introduced into the temperature controller needs to be cooled.

A coolant system of an electric vehicle according to an exemplary embodiment of the present disclosure includes: an integral valve that includes one or more coolant inlets and two or more coolant outlets, and selectively discharges a coolant through one of the coolant outlets; a plurality of coolant paths that are connected with each other such that the coolant discharged through one of the coolant outlets is introduced back into the integral valve through the one or more coolant inlets after being supplied to a portion where coolant circulation is required; and a temperature controller that is provided in at least one of the plurality of coolant paths to selectively control a temperature of the coolant.

The integral valve, at least a portion of the plurality of coolant paths, and the heat pump device may form one valve module.

According to the above-described exemplary embodiment of the present disclosure, a valve module that includes an integral valve and a temperature controller is applied to improve cooling efficiency of the electrically powered device with a simple configuration, and at the same time, a coolant can effectively circulate in the peripheral devices such as the radiator.

In addition, a minimal space for providing the valve module is required, which improves the space utilization and minimizes the need to perform additional heating and cooling of the coolant by using components such as a battery heater and a battery chiller, thereby maximizing space utilization.

Further, the elimination of certain unnecessary configurations can ultimately reduce cost and weight and improve fuel consumption.

### BRIEF DESCRIPTION OF THE DRAWINGS

FIG. 1 is a schematic diagram of a cooling system of an electric vehicle according to an exemplary embodiment of the present disclosure.

FIG. 2 is an operational diagram that shows circulation of a coolant realized in a coolant high-temperature environment of the cooling system of the electric device according to the exemplary embodiment of the present disclosure.

FIG. 3 is an operational diagram that shows coolant circulation realized in a coolant low-temperature environment of the cooling system of the electric vehicle according to the exemplary embodiment of the present disclosure.

FIG. 4 is schematic diagram that shows a configuration of a temperature controller, and a function of a temperature controller in a coolant low-temperature environment of the cooling system of the electric vehicle according to the exemplary embodiment of the present disclosure.

FIG. 5 is schematic diagram that shows a configuration of a temperature controller, and a function of a temperature controller in a coolant low-temperature environment of the cooling system of the electric vehicle according to another the exemplary embodiment of the present disclosure.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

An exemplary embodiment of the present disclosure will hereinafter be described in detail with reference to the accompanying drawings.

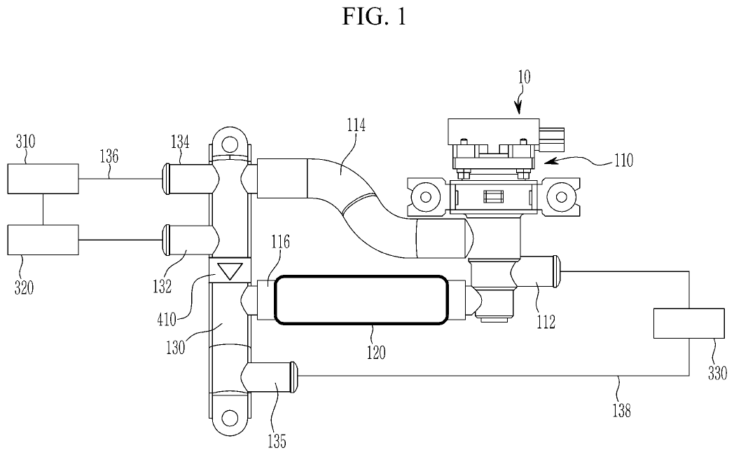

FIG. 1 is a schematic diagram of a cooling system of an electric vehicle according to an exemplary embodiment of the present disclosure.

As shown in FIG. 1, a cooling system of an electric vehicle according to an exemplary embodiment of the present disclosure is applied to an electric vehicle (EV), and includes a valve module 10 that functions to vary a circulation path of coolant according to an operating state of the vehicle, and coolant paths 112, 114, 116, 122, 124, 126, 128, 130, 132, 134, 136, and 138 that are provided for circulation of coolant in the valve module 10 and peripheral devices 310, 320, and 330.

The valve module 10 includes an integral valve 110, an integral valve inlet path 112, a first integral valve outlet path 114, a second integral valve outlet path 116, a temperature controller 120, an integrated battery cooling-cycle branch 130, an integrated battery cooling-cycle branch inlet path 132, a first integrated battery cooling-cycle branch outlet path 134, a second integrated battery cooling-cycle branch outlet path 135, and a check valve 410.

The integral valve 110 receives the coolant circulated while cooling an engine (not shown) or a driving motor (not shown), one or more of which may be power sources of the electric vehicle, and supplies the coolant to the peripheral devices 310, 320, and 330 that require circulation of the coolant, and receives the coolant that passed through the peripheral devices 310, 320, and 330 and supplies the coolant back to the engine or the drive motor and the peripheral devices 310, 320, and 330. That is, the integral valve 110 is a valve that controls coolant circulation of the electric vehicle, and a path through which the coolant flows into the integral valve 110 from the engine or the driving motor, which would be apparent to one skilled in the art, and thus will not be further described.

The integral valve inlet path 112 is another coolant inlet through which the coolant flows into the integral valve 110 in addition to a path through which the coolant flows into the integral valve 110 from the engine or the driving motor. In addition, the integral valve inlet path 112 is formed in the integral valve 110 such that the integral valve 110 receives the coolant that passed through the peripheral devices 310, 320, and 330.

The first integral valve outlet path 114 is one of coolant outlets through which the coolant is selectively discharged from the integral valve 110. In addition, the first integral valve outlet path 114 is formed in the integral valve 110 such that the integral valve 110 discharges the coolant.

The second integral valve outlet path 116 is another coolant outlet through which the coolant is selectively discharged from the integral valve 110. In addition, the second integral valve outlet path 116 is formed in the integral valve 110 such that the integral valve 110 discharges the coolant. That is, the integrated valve 110 functions to let the coolant introduced into the integral valve inlet path 112 to be discharged through one of the first integral valve outlet path 114 and the second integral valve outlet path 116.

The temperature controller 120 is a device provided in the second integral valve outlet path 116, and selectively controls a temperature of the coolant. In other words, the temperature controller 120 selectively performs one of a function of raising the temperature of the coolant or a function of lowering the temperature of the coolant.

The integrated battery cooling-cycle branch 130 is communicated with the first integral valve outlet path 114 and the second integral valve outlet path 116 such that the coolant circulates while passing through the first integral valve outlet path 114 or the second integral valve outlet path 116.

The first integrated battery cooling-cycle branch outlet path 134 is one coolant outlet through which the coolant is discharged from the integrated battery cooling-cycle branch 130. In addition, the first integrated battery cooling-cycle branch outlet path 134 is formed in the integrated battery cooling-cycle branch 130 such that the integrated battery cooling-cycle branch 130 can discharge the coolant. Further, the first integrated battery cooling-cycle branch outlet path 134 may be disposed, while opposing the first integral valve outlet path 114 such that the coolant introduced into the integrated battery cooling-cycle branch 130 can be easily discharged through the first integral valve outlet path 114.

The integrated battery cooling-cycle branch inlet path 132 is another coolant inlet through which the coolant is introduced into the integrated battery cooling-cycle branch 130, in addition to a path through which the coolant is introduced into the integrated battery cooling-cycle branch 130 from the first integral valve outlet path 114 or the second integral valve outlet path 116. In addition, the integrated battery cooling-cycle branch inlet path 132 is formed in the integrated battery cooling-cycle branch 130 such that the integrated battery cooling-cycle branch 130 can receive the coolant.

The second integrated battery cooling-cycle branch outlet path 135 is another coolant outlet through which the coolant is discharged from the integrated battery cooling-cycle branch 130. In addition, the second integrated battery cooling-cycle branch outlet path 135 is formed in the integrated battery cooling-cycle branch 130 such that the integrated battery cooling-cycle branch 130 can discharge the coolant. Meanwhile, when a circulation direction of the coolant with reference to the integrated battery cooling-cycle branch 130 is set to a length direction of the integrated battery cooling-cycle branch 130, it is preferred that the first integrated battery cooling-cycle branch outlet path 134 and the first integral valve outlet path 114 are disposed (on the same line) along the length direction of the integrated battery cooling-cycle branch 130, the second integral valve outlet path 116 is disposed between the first integral valve outlet path 114 and the second integrated battery cooling-cycle branch outlet path 135, and the integrated battery cooling-cycle branch inlet path 132 is disposed between the first integral valve outlet path 114 and the second integral valve outlet path 116. Further, a portion where the first integrated battery cooling-cycle branch outlet path 134 is formed and a portion where the integrated battery cooling-cycle branch inlet path 132 is formed may be partitioned in the integrated battery cooling-cycle branch 130, but this is not restrictive.

The check valve 410 is provided in the integrated battery cooling-cycle branch 130. In addition, the check valve 410 is disposed between the second integral valve outlet path 116 and the integrated battery cooling-cycle branch inlet path 132 in a length direction of the integrated battery cooling-cycle branch 130. Further, the check valve 410 prevents the coolant passing through the second integral valve outlet path 116 from flowing backward toward the first integral valve outlet path 114, the first integrated battery cooling-cycle branch outlet path 134, and the integrated battery cooling-cycle branch inlet path 132 when the coolant is circulated to the second integrated battery cooling-cycle branch outlet path 135 through the integrated battery cooling-cycle branch 130.

The peripheral devices 310, 320, and 330 include a radiator 310, a condenser 320, and an electrically powered device 330.

The radiator 310 is a device that discharges heat of the coolant to the air, and the condenser 320 is a device that condenses an evaporated refrigerant by using the coolant, and they are apparent to those skilled in the art so that a detailed description thereof will be omitted.

The electrically powered device 330 is defined to generically refer to power electronics (PE) and a high voltage battery. Meanwhile, the electrically powered device 330 may be one or both of the power electronics and the high voltage battery. In general, a driving motor, a high voltage battery, a transmission, and a power electronic component are mounted as a power source in an electric vehicle. Here, a power electronic component is a device that performs functions such as converting DC power into AC power, transforming a voltage, synchronizing a connector, and the like, and is well known to those skilled in the art. Also, it would be apparent to a person skilled in the art that the high voltage battery supplies power to the driving motor. In such an electric vehicle, properly maintaining a temperature of the electrically powered device 330 may determine the performance of the electric vehicle.

The coolant discharged through the first integrated battery cooling-cycle branch outlet path 134 from the integrated battery cooling-cycle branch 130 passes through a first circulation path 136 and then is introduced into the integrated battery cooling-cycle branch 130 through the integrated battery cooling-cycle branch inlet path 132. In addition, the radiator 310 and the condenser 320 are provided on the first circulation path 136. That is, the coolant that passed through the first circulation path 136 then passes through the radiator 310 and the condenser 320.

The coolant discharged through the second integrated battery cooling-cycle branch outlet path 135 from the integrated battery cooling-cycle branch 130 is introduced into the integral valve 110 through the integral valve inlet path 112 after passing through a second circulation path 138. In addition, the electrically powered device 330 is provided on the second circulation path 138. That is, the coolant that passes through the second circulation path 138 passes through the electrically powered device 330.

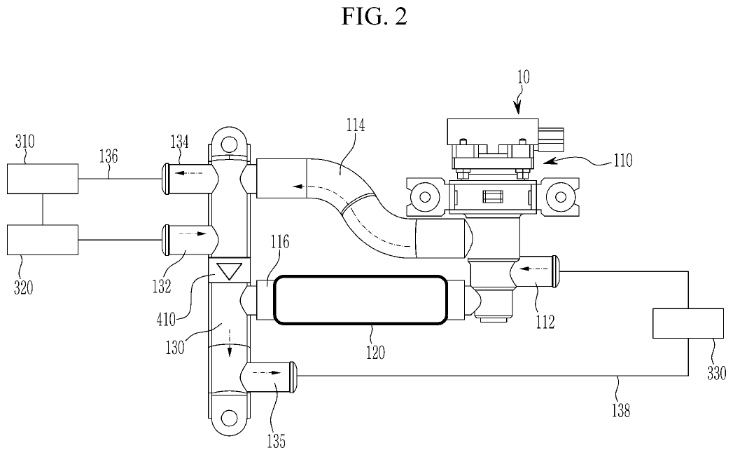

FIG. 2 is an operational diagram that shows circulation of a coolant realized in a coolant high-temperature environment of the cooling system of the electric device according to the exemplary embodiment of the present disclosure.

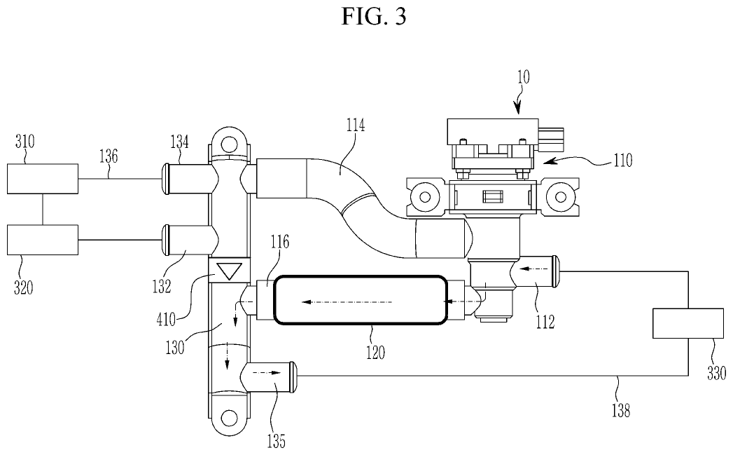

As shown in FIG. 2, since cooling of the coolant using the radiator 310 is required in the coolant high temperature environment, the integral valve 110 opens the first integral valve outlet path 114 and closes the second integral valve outlet path 116. The coolant discharged through the first integral valve outlet path 114 from the integral valve 110 by such an operation of the integral valve 110 sequentially passes through the integrated battery cooling-cycle branch 130, the first integrated battery cooling-cycle branch outlet path 134, the first circulation path 136, the integrated battery cooling-cycle branch inlet path 132, the integrated battery cooling-cycle branch 130, the second integrated battery cooling-cycle branch outlet path 135, the second circulation path 138, and the integral valve inlet path 112, and then is introduced into the integral valve 110. FIG. 3 is an operational diagram that shows coolant circulation realized in a coolant low-temperature environment of the cooling system of the electric vehicle according to the exemplary embodiment of the present disclosure.

As shown in FIG. 3, since cooling of the coolant by using the radiator 310 is not required in the coolant low-temperature environment, the integral valve 110 closes the first integral valve outlet path 114 and opens the second integral valve outlet path 116. Due to such an operation of the integral valve 110, the coolant discharged through the second integral valve outlet path 116 from the integral valve 110 is introduced into the integral valve 110 after sequentially passing through the integrated battery cooling-cycle branch 130, the second integrated battery cooling-cycle branch outlet path 135, the second circulation path 138, and the integral valve inlet path 112.

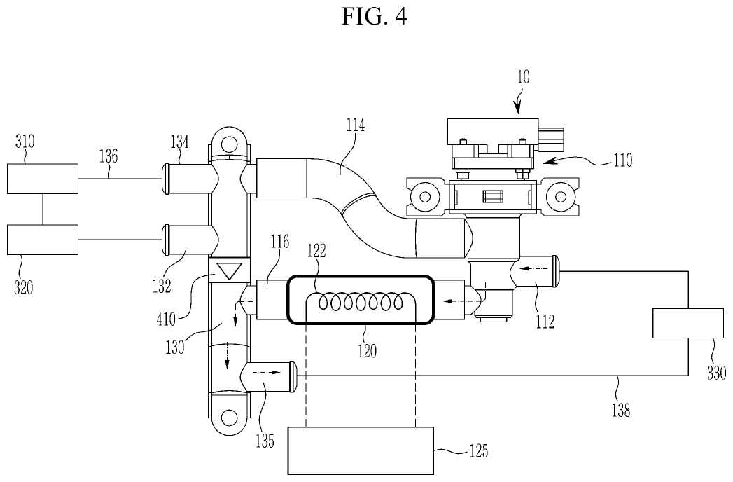

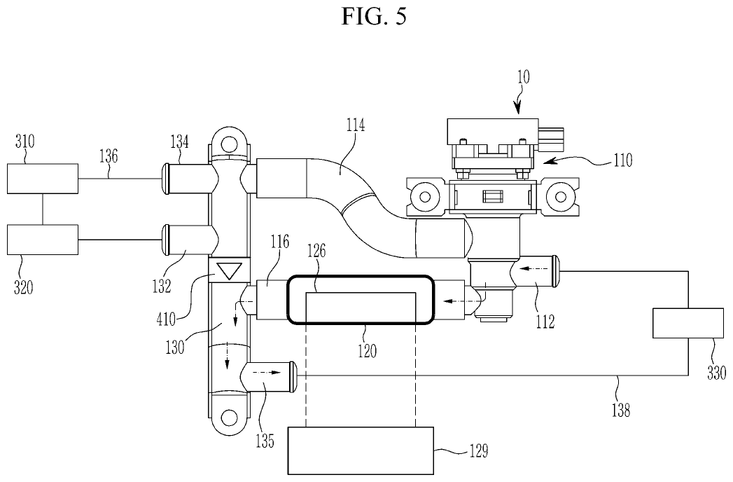

Here, an operation of controlling the temperature of the coolant by the configuration and function of the temperature controller 120 according to one embodiment of the present disclosure will be described with reference to FIG. 4, and an operation of controlling the temperature of the coolant by the configuration and function of the temperature controller 120 according to another embodiment of the present disclosure will be described with reference to FIG. 5.

FIG. 4 is schematic diagram that shows a configuration of a temperature controller, and a function of a temperature controller in a coolant low-temperature environment of the cooling system of the electric vehicle according to the exemplary embodiment of the present disclosure.

As shown in FIG. 4, the temperature controller 120 according to one exemplary embodiment of the present disclosure includes a heat coil 122 and a coil heating portion 125.

The heat coil 122 is embedded in the temperature controller 120 which is provided in the second integral valve outlet path 116. In addition, the heat coil 122 selectively generates heat so as to heat the coolant passing through the temperature controller 120 while passing through the second integral valve outlet path 116. Further, the heat coil 122 may be formed into a cylindrical shape by winding a thin metal wire several times in parallel around one axis, and it would be apparent to those skilled in the art that heat is generated due to resistance as current flows.

The coil heating portion 125 is provided to be connected to the heat coil 122 and functions to heat the heat coil 122. The coil heating portion 125 may be an electric power source that induces heat generation of the heat coil 122 by causing a current to flow through the heat coil 122.

When it is required to raise the temperature of the coolant flowing into the temperature controller 120 in the low-temperature environment of the coolant, the coil heating portion 125 allows the heat coil 122 to generate heat. The coolant passes through the second integral valve outlet path 116 such that is rises in temperature by heat exchange with the heat coil 122 while passing through the temperature controller 120, and then passes through the second circulation path 138. Accordingly, the coolant having a proper temperature can circulate in the electrically powered device 330.

When it is not required to raise the temperature of the coolant flowing into the temperature controller 120 in the low-temperature environment of the coolant, the coil heating portion 125 and the heat coil 122 are not operated. Thus, the heat coil 122 for heating the coolant passing through the temperature controller 120 and the coolant are not heat-exchanged each other, and the coolant having a proper temperature can circulate in the electrically powered device 330.

Meanwhile, in the case where the temperature controller 120 according to one exemplary embodiment of the present disclosure is applied, a configuration for performing additional heating of the coolant such as a battery heater may be eliminated.

FIG. 5 is schematic diagram that shows a configuration of a temperature controller, and a function of a temperature controller in a coolant low-temperature environment of the cooling system of the electric vehicle according to another the exemplary embodiment of the present disclosure.

As shown in FIG. 5, the temperature controller 120 according to another exemplary embodiment of the present disclosure includes a refrigerant circulation path 126 connected to air conditioner 129 of the vehicle.

The air conditioner 129 may be a conventional air conditioner of the vehicle or a part thereof, and it would be apparent to those skilled in the art that a refrigerant is used to perform the function of a conventional air conditioner of a vehicle.

The refrigerant circulation path 126 is embedded in the temperature controller 120 which is provided in the second integral valve outlet path 116. In addition, the air conditioner 129 is connected with the refrigerant circulation path 126, and the refrigerant of the air conditioner 129 passes through the refrigerant circulation path 126. Further, the refrigerant circulation paths 126 may be provided such that heat exchange can be carried out between the refrigerant and the coolant, while being distinguished with the paths of the coolant.

When it is required to lower the temperature of the coolant flowing into the temperature controller 120 in the low-temperature environment of the coolant, the air conditioner 129 allows a low-temperature refrigerant to pass through the refrigerant circulation paths 126. The coolant passes through the second integral valve outlet path 116 such that it is lowered in temperature by heat exchange with the refrigerant while passing through the temperature controller 120, and then passes through the second circulation path 138. Accordingly, the coolant having a proper temperature can circulate in the electrically powered device 330.

When it is not required to lower the temperature of the coolant flowing into the temperature controller 120 in the low-temperature environment of the coolant, the air conditioner 129 and the refrigerant circulation path 126 are not operated. Thus, the refrigerant circulation paths 126 for cooling the coolant passing through the temperature controller 120 and the coolant are not heat-exchanged each other, and the coolant having a proper temperature can circulate in the electrically powered device 330. Meanwhile, in the case where the temperature controller 120 according to another exemplary embodiment of the present disclosure is applied, a configuration for performing additional cooling of the coolant such as a battery chiller may be eliminated.

In the present specification, a method for controlling the valve module 10, such as sensing a temperature of the coolant using a temperature sensor and the like and controlling the integral valve 110, the coil heating portion 125, and the air conditioner 129 depending on the sensed temperature of the cooler by using a controller such as a general electronic control unit (ECU) that manages control of electronic devices of the vehicle, and matters related to the method will be omitted. Such a control method of the valve module 10 may be variously implemented depending on designs of person of ordinary skill in the art.

According to the above-described exemplary embodiment of the present disclosure, the valve module 10 that includes integral valve 110 and temperature controller 120 is applied to improve cooling efficiency of the electrically powered device 330 with a simple configuration, and at the same time, the coolant can effectively circulate in the peripheral devices 310 and 320 such as the radiator 310. In addition, a minimal space for providing the valve module 10 is required, which improves the space utilization and minimizes the need to perform additional heating and cooling of the coolant, for example, by using a battery heater and/or a battery chiller, thereby maximizing space utilization. Further, the elimination of simple configurations and unnecessary configurations can ultimately reduce cost and weight and improve fuel consumption.

While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of the appended claims.

What is claimed is:

1. A cooling system of an electric vehicle configured to change a circulation path of coolant according to operation of a valve module, comprising:
an integral valve that supplies the coolant to a portion where circulation of the coolant is required while cooling a power source of the electric vehicle, and then receives the coolant to supply the received coolant back to the power source and the portion where the coolant circulation is required;
an integral valve inlet path through which the coolant is introduced into the integral valve;
a first integral valve outlet path, which is one outlet through which the coolant is selectively discharged from the integral valve;
a second integral valve outlet path, which is another coolant outlet through which the coolant is selectively discharged from the integral valve;
a temperature controller provided for passing the coolant passing through the second integral valve outlet path and selectively controlling a temperature of the coolant passing therethrough;
an integrated battery cooling-cycle branch communicating with the first integral valve outlet path and the second integral valve outlet path;
a first integrated battery cooling-cycle branch outlet path, which is one outlet through which the coolant is discharged from the integrated battery cooling-cycle branch;
an integrated battery cooling-cycle branch inlet path through which the coolant is introduced into the integrated battery cooling-cycle branch; and
a second integrated battery cooling-cycle branch outlet path, which is another outlet through which the coolant is discharged from the integrated battery cooling-cycle branch.

2. The cooling system of the electric vehicle of claim 1, wherein the integral valve inlet path, the first integral valve outlet path, and the second integral valve outlet path are formed in the integral valve.

3. The cooling system of the electric vehicle of claim 1, wherein the first integrated battery cooling-cycle branch outlet path, the integrated battery cooling-cycle branch inlet path, and the second integrated battery cooling-cycle branch outlet path are formed in the integrated battery cooling-cycle branch.

4. The cooling system of the electric vehicle of claim 1, wherein the first integrated battery cooling-cycle branch outlet path is disposed while opposing the first integral valve outlet path such that the coolant introduced into the integrated battery cooling-cycle branch through the first integral valve outlet path is discharged through the first integral valve outlet path.

5. The cooling system of the electric vehicle of claim 1, wherein the first integrated battery cooling-cycle branch outlet path and the first integral valve outlet path are disposed along a length direction of the integrated battery cooling-cycle branch, which is a direction in which the coolant circulates in the integrated battery cooling-cycle branch, the second integral valve outlet path is disposed between the first integral valve outlet path and the second integrated battery cooling-cycle branch outlet path, and the integrated battery cooling-cycle branch inlet path is disposed between the first integral valve outlet path and the second integral valve outlet path.

6. The cooling system of the electric vehicle of claim 5, wherein the valve module further comprises a check valve that is disposed between the second integral valve outlet path and the integrated battery cooling-cycle branch inlet path in the length direction of the integrated battery cooling-cycle branch to prevent the coolant that has passed through the second integral valve outlet path from flowing backward toward the first integral valve outlet path, the first integrated battery cooling-cycle branch outlet path, and the integrated battery cooling-cycle branch inlet path when circulating to the second integrated battery cooling-cycle branch outlet path through the integrated battery cooling-cycle branch.

7. The cooling system of the electric vehicle of claim 1, wherein the coolant discharged through the first integrated battery cooling-cycle branch outlet from the integrated battery cooling-cycle branch is introduced into the integrated battery cooling-cycle branch through the integrated battery cooling-cycle branch inlet path after passing through a first circulation path, and
a radiator is provided on the first circulation path such that the coolant passing through the first circulation path passes through the radiator.

8. The cooling system of the electric vehicle of claim 7, wherein the coolant discharged through the second integrated battery cooling-cycle branch outlet path from the integrated battery cooling-cycle branch is introduced through the integral valve inlet path after passing through a second circulation path, and
an electrically powered device is provided on the second circulation path such that the coolant passing through the second circulation path passes through the electrically powered device.

9. The cooling system of the electric vehicle of claim 8, wherein when the integral valve operates to open the first integral valve outlet path and close the second integral valve outlet path,
the coolant discharged through the first integral valve outlet path from the integral valve sequentially passes through the integrated battery cooling-cycle branch, the first integrated battery cooling-cycle branch outlet path, the first circulation path, the integrated battery cooling-cycle branch inlet path, the integrated battery cooling-cycle branch, the second integrated battery cooling-cycle branch outlet path, and the second circulation path, and the integrated battery cooling-cycle branch inlet path, and then is introduced into the integral valve.

10. The cooling system of the electric vehicle of claim 9, wherein the operation of the integral valve is carried out when the coolant needs to be cooled by using the radiator in a coolant high-temperature environment.

11. The cooling system of the electric vehicle of claim 8, wherein when the integral valve operates to close the first integral valve outlet path and open the second integral valve outlet path,
the coolant discharged through the second integral valve outlet path from the integral valve is introduced into the integral valve after sequentially passing through the integrated battery cooling-cycle branch, the second integrated battery cooling-cycle branch outlet, the second circulation path, and the integrated battery cooling-cycle branch inlet path.

12. The cooling system of the electric vehicle of claim 11, wherein the temperature controller further comprises:
a heat coil selectively generating heat to heat the coolant passing through the second integral valve outlet path; and
a coil heating portion provided to be connected to the heat coil to induce heat generation of the heat coil.

13. The cooling system of the electric vehicle of claim 12, wherein when the heat coil generates heat, the coolant that passed through the second integral valve outlet path rises in temperature by heat exchange with the heat coil while passing through the temperature controller, and then passes through the second circulation path.

14. The cooling system of the electric vehicle of claim 13, wherein the operation of the integral valve is carried out when the coolant does not need to be cooled by using the radiator in a coolant low-temperature environment, and
the operation of the heat coil is carried out when the coolant introduced into the temperature controller needs to be heated.

15. The cooling system of the electric vehicle of claim 11, wherein the temperature controller further comprises:
a refrigerant circulation path through which a low-temperature refrigerant is selectively passed to cool the coolant passing through the second integral valve outlet path,
wherein a refrigerant passing through the refrigerant circulation path is supplied from an air conditioner.

16. The cooling system of the electric vehicle of claim 15, wherein the refrigerant circulation path is provided to perform heat exchange between the refrigerant and the coolant while being distinguished from a path of the coolant.

17. The cooling system of the electric vehicle of claim 15, wherein when the low-temperature refrigerant passes through the refrigerant circulation path, the coolant passing through the second integral valve outlet path lowers in temperature by heat exchange with the refrigerant while passing through the temperature controller, and then passes through the second circulation path.

18. The cooling system of the electric vehicle of claim 17, wherein the operation of the integral valve is carried out when the coolant does not need to be cooled by using the radiator in the coolant low-temperature environment, and
the operation of the refrigerant circulation paths is carried out when the coolant that is introduced into the temperature controller needs to be cooled.

19. A cooling system of an electric vehicle, comprising:
an integral valve that includes one or more coolant inlets and two or more coolant outlets, and selectively discharges a coolant through one of the coolant outlets;
a plurality of coolant paths that are connected with each other such that the coolant discharged through one of the coolant outlets is introduced back into the integral valve through the one or more coolant inlets after being supplied to a portion where coolant circulation is required; and
a temperature controller that is provided in at least one of the plurality of coolant paths to selectively control a temperature of the coolant,
wherein the integral valve, at least a portion of the plurality of coolant paths, and the temperature controller form one valve module.
